(19) United States
(12) Patent Application Publication
(10) Pub. No.: US 2025/0072546 A1
(43) Pub. Date: Mar. 6, 2025

(54) HEAD GUARD PAD

(71) Applicant: ODM GMBH, Wattenheim (DE)

(72) Inventor: Christopher KÜHN, Wattenheim (DE)

(21) Appl. No.: 18/698,493

(22) PCT Filed: Sep. 28, 2022
(86) PCT No.: PCT/EP2022/077049

§ 371 Date: Apr. 4, 2024

(30) Foreign Application Priority Data
Oct. 4, 2021 (DE) 10 2021 125 697.6
Oct. 4, 2021 (DE) 10 2021 125 701.8

(51) Int. Cl. A42B 3/12

(52) U.S. Cl. CPC A42B 3/125

(57) ABSTRACT

A head protection pad for insertion into a helmet with a base body made of padding material and a cover which at least partially surrounds the base body, wherein the cover has an outer layer and at least one inner layer, wherein the outer layer is designed as a cooling layer and has a cooling medium integrated into the outer layer.

### FIELD OF THE INVENTION

The invention relates to a head protection pad for insertion into a helmet or helmet cover and has a base body made of padding material and a cover which at least partially surrounds the base body.

### BACKGROUND OF THE INVENTION

A head protection pad for insertion into a helmet or a helmet cover is already generally known, whereby the head protection pad has a base body made of foam surrounded by a cover made of textile fabric.

### SUMMARY OF THE INVENTION

The invention is based on the task of forming and arranging head protection pads for insertion into a helmet cover in such a way that an advantageous effect is achieved.

The problem is solved according to the invention in that the cover has an outer layer and at least one inner layer, the outer layer being designed as a cooling layer and having a cooling medium integrated into the outer layer. The cooling medium is a so-called pcm (phase change material), which can absorb body heat, whereby it at least partially changes its aggregate state from solid to liquid. This ensures temperature equalisation between the inner layer of fabric and the scalp. This results in greater wearing comfort. The outer layer, which is designed as a cooling layer, lies directly against the head and ensures a corresponding cooling effect.

It can also be advantageous if the outer layer and/or the inner layer is made of textile fabric. The respective layer can advantageously be designed as a fabric layer with corresponding woven structures of the fabric fibres. Depending on the material used, a fabric has favourable physical properties. For example, it is stronger or more resistant. A non-woven material may have a lower density and would therefore be lighter.

It can also be advantageous if paraffin is used as the cooling medium. The paraffin is stabilised and has a defined melting point of around 30° C. In the case of a fabric layer, the paraffin is integrated into the fabric layer or absorbed by the fabric layer. The paraffin can be integrated into the outer layer in the form of microcapsules. When heat is applied, the paraffin changes its aggregate state from solid to liquid and absorbs excess heat from the head.

It can also be advantageous if a spacer layer is provided, which is arranged between the inner layer and the outer layer. The spacer layer ensures or supports the cooling effect of the cooling layer. The spacer layer has a thickness of 4.5 mm to 7 mm or 5.5 mm to 6 mm. The cooling effect of the outer layer is improved by the spacer layer and the associated air cushion. It also improves the drying of the outer layer and thus also the absorption of perspiration.

It can be advantageous if the spacer layer is directly adjacent to the outer layer. This ensures that the cooling effect of the cooling layer is supported.

It can be of particular importance for the present invention if the spacer layer is woven with the outer layer and/or that the spacer layer is woven with the inner layer. This ensures a stable structure.

In connection with the design and arrangement according to the invention, it can be advantageous if the spacer layer is formed from a large number of sticks or hair arranged parallel to each other or at an acute angle α to each other, which are aligned transversely to the outer layer. It can also be advantageous if a surface density of 2,500 or between 2,000 and 1,0000 sticks per cm² is provided. This ensures stability despite rear ventilation.

It can also be advantageous if the spacer layer has a thickness of at least 5 mm. The thickness is determined in the unloaded state.

It can be advantageous if the spacer layer has a specific weight of 200 g/m² or between 150 g/m² and 300 g/m².

The head protection pads are also used for bulletproof vests, heavy protective clothing, impact protection elements, motorbike clothing and other impact protection headgear. Lighter qualities are also used as inner linings for leisure jackets and trousers as well as gloves.

It can also be advantageous if the base body is made of foam and/or a gel. In the case of gel, the base body is designed as a gel cushion with an outer cover in which the gel is contained. The cover can be bonded to the foam or the gel cushion.

### BRIEF DESCRIPTION OF THE DRAWINGS

Further advantages and details of the invention are explained in the patent claims and in the description and shown in the figures. It shows:

FIG. 1 is a perspective view of a head protection pad;

FIG. 2a sectional view of a head protection pad with base body;

FIG. 2a sectional view of the cover of the head protection pad;

FIG. 3a detailed view of the cover according to FIG. 2b;

FIG. 3 is a detailed view of a relative embodiment;

FIG. 4 is a schematic representation of a helmet or helmet covers with head protection pads.

### DETAILED DESCRIPTION OF THE INVENTION

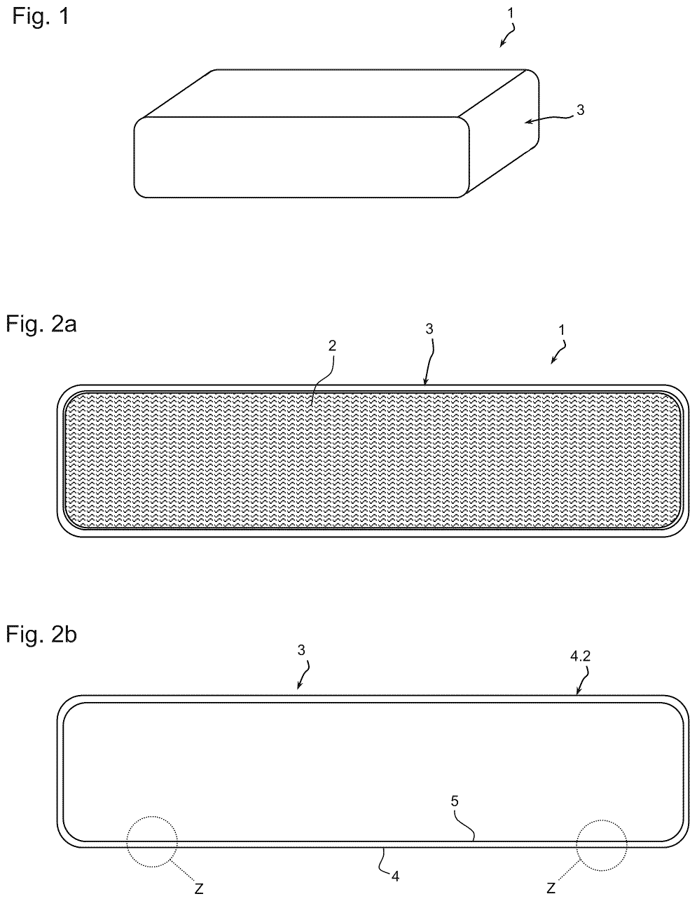

The head protection pad 1 shown in FIG. 1 is cushion-shaped and has a cover 3. The head protection pad 1 formed in this way is attached to the inner side 8.1 of a helmet or helmet cover 8 as shown in FIG. 4 using retaining means not shown, such as adhesive tape or adhesive.

According to FIG. 2a, the head protection pad 1 has an internal base body 2, which is usually made of a foam material. The base body 2 is surrounded on all sides by the cover 3.

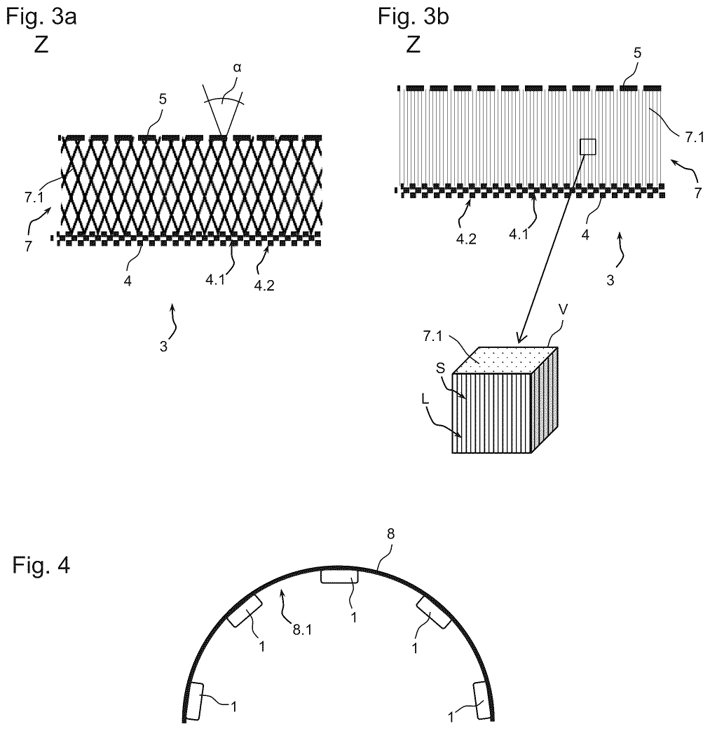

According to FIG. 2b, the cover 3 has an outer layer 4 and an inner layer 5. The outer layer 4 is in contact with a head to be protected. The outer layer 4 also has a cooling medium 4.1, which is integrated into the outer layer 4 in the form of microcapsules. According to the following detailed views Z as shown in FIG. 3a and FIG. 3b, the cover 3 has a three-layer structure. The outer layer 4 also has an outer surface 4.2.

According to FIGS. 3a, 3b, the cover 3 has the aforementioned outer layer 4 and the inner layer 5 as well as a spacer layer 7 arranged between the outer layer 4 and the inner layer 5. The cover 3 has a thickness of approx. 3 to 5 mm and a specific weight per unit area of 450 to 700 g/m². While the outer layer 4 and the inner layer 5 are formed from a textile material, the spacer layer 7 has a rod or hair structure. According to the example in FIG. 3a, the hair or sticks 7.1 are arranged at an angle α to each other. This angle α is an acute angle of about 40°. According to the embodiment example in FIG. 3b, the sticks or hair 7.1 are aligned parallel to each other and at the same time normal to the neighbouring outer layer 4 or inner layer 5. The spacer layer 7 is mechanically connected to both the outer layer 4 and the inner layer 5, for example by weaving.

As shown in principle in FIG. 3b, the spacer layer 7 has a volume V, which is composed of the volume S of the sticks 7.1 located therein and the remaining air volume L. The ratio L/V of air volume L to total volume V is at least 0.9 or at least 0.95. A surface density of 1,500 to 3,000 sticks 7.1 per cm² is provided.

As shown in FIGS. 3a, 3b, the outer layer 4 has the outer surface 4.2 with a grey colour. In addition, the outer layer 4 has a cooling medium 4.1, which is in the form of microcapsules and is integrated into the outer layer 4.

According to embodiment example FIG. 4, several head protection pads 1 are attached to an inner side 8.1 of a helmet 8 or a helmet cover via said connecting means such as Velcro fasteners, so that the head protection pads 1 can be brought into contact with the head when the helmet 8 is put on. The contact against the head takes place directly via the outer layer 4, which is provided with cooling medium 4.1.

### LIST OF REFERENCE SYMBOLS

1 Head protection pad
2 Base body, foam
3 Cover
4 Outer layer
4.1 Cooling medium
4.2 Outer surface
5 Inner layer
7 Spacer layer
7.1 Sticks, hair
8 Helmet cover, helmet
8.1 Inner side of 8
L Air volume
S Volume from 7.1
V Volume
α Angle

What is claimed is:

1. A head protection pad for insertion into a helmet, comprising:
a base body made of padding material and a cover which at least partially surrounds the base body,
wherein the cover has an outer layer and at least one inner layer, the outer layer being designed as a cooling layer and having a cooling medium integrated into the outer layer,
wherein the outer layer is formed from textile material; and
wherein a spacer layer is provided, which is arranged between the inner layer and the outer layer.

2. The head protection pad according to claim 1, wherein the outer layer and the inner layer are formed from textile material.

3. The head protection pad according to claim 1, wherein paraffin is provided as the cooling medium, the paraffin being integrated into the outer layer in the form of microcapsules or being absorbed by the outer layer.

4. (canceled)

5. The head protection pad according to claim 3, wherein the spacer layer is directly adjacent to the outer layer.

6. The head protection padding according to claim 3, wherein the spacer layer is interwoven with the outer layer and/or that the spacer layer is interwoven with the inner layer.

7. The head protection pad according to claim 3, wherein the spacer layer is formed from a plurality of sticks or hair arranged parallel to each other or at an acute angle α to each other, which are aligned transversely to the outer layer.

8. The head protection pad according to claim 7, wherein a surface density of 2500 sticks per cm² is provided.

9. The head protection pad according to claim 3, wherein the spacer layer has a thickness of at least 5 mm.

10. The head protection padding according to claim 3, wherein that the spacer layer has a specific weight of 200 g/m².

11. The head protection pad according to claim 1, wherein the base body is formed from foam and/or from a gel.

12. A system, comprising:
at least one head protection pad according to claim 1 and a helmet cover, wherein the at least one head protection pad is attached to an inner side of the helmet cover.

13. A use of a head protection pad according to claim 1 in a helmet cover as an abutment for a head.

14. A use of a head protection pad according to claim 1 for impact protection waistcoats and impact protection trousers as an attachment for the arms or the legs or the torso.

15. The head protection pad according to claim 2, wherein paraffin is provided as the cooling medium, the paraffin being integrated into the outer layer in the form of microcapsules or being absorbed by the outer layer.

16. The head protection pad according to claim 15, wherein the spacer layer is directly adjacent to the outer layer, and wherein the spacer layer is interwoven with the outer layer and/or that the spacer layer is interwoven with the inner layer.

17. The head protection pad according to claim 16, wherein the spacer layer is formed from a plurality of sticks or hair arranged parallel to each other or at an acute angle α to each other, which are aligned transversely to the outer layer, and wherein a surface density of 2500 sticks per cm² is provided.

18. The head protection pad according to claim 17, wherein the spacer layer has a thickness of at least 5 mm, wherein that the spacer layer has a specific weight of 200 g/m², and wherein the base body is formed from foam and/or from a gel.

19. A system, comprising:
at least one head protection pad according to claim 18 and a helmet cover, wherein the
at least one head protection pad is attached to an inner side of the helmet cover.

20. A use of a head protection pad according to claim 18 in a helmet cover as an abutment for a head.
